(19) United States
(12) Patent Application Publication
(10) Pub. No.: US 2024/0241583 A1
(43) Pub. Date: Jul. 18, 2024

(54) System and Method for Haptic Stimulation in a Multi-player System

(71) Applicants: Kfir BARLEVAV, Elad (IL); Mor Efrati, Tel Aviv (IL); Uri Kareev, Tel Aviv (IL); Boaz Feldman, Petach-Tikva (IL); Noam Barlevav, Kfar-Saba (IL)

(72) Inventors: Kfir BARLEVAV, Elad (IL); Mor Efrati, Tel Aviv (IL); Uri Kareev, Tel Aviv (IL); Boaz Feldman, Petach-Tikva (IL); Noam Barlevav, Kfar-Saba (IL)

(21) Appl. No.: 18/411,610

(22) Filed: Jan. 12, 2024

Related U.S. Application Data
(60) Provisional application No. 63/438,565, filed on Jan. 12, 2023.

(51) Int. Cl. G06F 3/01

(52) U.S. Cl. CPC G06F 3/016; G06F 3/011; A63F 13/28

(57) ABSTRACT

The invention provides a system for generating a haptic stimulation interaction among two or more users. Each user is provided with a user apparatus having a haptic communication driving unit (HCDU) that includes a transceiver enabling each HCDU to communicate with other HCDUs in the system, and a computer processing unit (CPU). Each HCDU has one or more associated haptic devices adapted to be applied to one or more body surfaces of the user. The CPU of a first HCDU is configured to determine one or more first haptic signals, and to transmit the determined first haptic signals to one or more second HCDUs in the system. Upon receipt of the first haptic signal at one or more second HCDUs, the CPU of each second HCDU generates a second haptic signal that is sent to one or more of the haptic devices associated with the second HCDU to generate one or more haptic effects.

### FIELD OF THE INVENTION

This invention relates to systems providing haptic stimulation.

### BACKGROUND OF THE INVENTION

Various forms of content, such as video games, music, and video programs can be enhanced by providing haptic stimulation to a user that complements the content. For example, a haptic device can be used to generate a vibrational effect or audio effect that complements events occurring in the content. Typically, these haptic effects are predetermined by the content developer. A video game program may be pre-programmed to induce certain haptic effects when certain events occur during execution of the program. The haptic effects experienced by a user are thus limited to those pre-programmed by the content developer. Moreover, for video games without any pre-programmed instructions to induce haptic effects, these haptic effects are usually not available to the player.

Systems are also known that include an interface to audio content, such as an audio track of a video game, a song, or a movie, that analyzes the audio signals of the audio content and generates from the audio signals haptic commands that are used to drive a haptic device. These systems typically use a look-up table that determines a haptic effect for each of one or more characterizations of the parameters of the audio signal, such as a specific range of frequencies. US published patent publication 20110190058 to Houston, describes such a system. However, in these systems, typically only one haptic effect is available for each possible characterization of the audio parameters. Thus, these systems do not allow selection of a haptic effect from two or more haptic effects that may be realistic for the pervading characterization of the audio parameters when other factors are considered in determining the haptic signal to be generated.

### SUMMARY OF THE INVENTION

The present invention provides system for generating of haptic stimulation. The system of the invention is used by two or more users. The invention comprises a plurality of haptic communication driving unit (HCDU), each user being provided with an HCDU. The HCDU also includes a computer processing unit (CPU). Each HCDU also includes a transceiver that allows each HCDU of the system to communicate with the other HCDUs of the system, as explained below. The HCDUs may also include a user input device, for example, a keypad, touch screen, or joy-stick The HCDUs may also include a screen providing a user with relevant information or images.

Each HUCD has one or more associated haptic devices. The haptic devices are configured to be are applied to a body surface of a user. For example, the haptic devices may be incorporated into a vest worn on the torso of the user, or in the form of a wrist band worn around the user's wrist. A haptic device may be incorporated into a furniture item such as a chair or couch. The each haptic device comprise one or more haptic transducers that convert electric signals into haptic signals which generate haptic effects in one or more locations on the body surface of the user to which the haptic device is applied.

The HCDUs the system communicate with each other over a communication line that may be a wired connection or a wireless connection. If the users are located in proximity to each other, for example, in the same room, the communication line may be, for example, a WiFi or Bluetooth communication channel. If the users are remotely located, the HCDUs may communicate over the Internet, or a local area network (LAN).

Users may also be provided with one or more body sensors such as any one or more of a motion detectors that sense motion or movement of the user, or a physiological sensor sensing a physiological parameter of the user such as pulse rate, breathing rate, body temperature, skin conductance or blood oxygen level. Each body sensor generates an input to the CPU of the user's HCDU. In this case, the CPU is configured to analyze signals input from the one or more body sensors and detect a motion, gesture, or movement performed by the user and/or to determine values of any one or more of the various physiological body parameters.

A user's CPU is further configured to generate a first haptic signal and to transmit the first haptic signal to one or more other HCDUs in the system over the communication channel. Upon receipt of the first haptic signal by a second HCDU, the received first haptic signal is analyzed by the CPU of the second HCDU to determine an appropriate second haptic signal and to send the second haptic signal to the haptic device associated with the second HCDU.

Generation of the first haptic signal may occur when any one or more predetermined conditions are met. For example, a command input to a first HCDU could activate the CPU of the first HCDU to generate a first haptic signal corresponding to the command. Alternatively or additionally, the CPU of the first HCDU may generate a first haptic signal when a particular motion or gesture, or when any one or more physiological parameters of user of the first HCDU satisfy one or more predetermined conditions. Such conditions may be, for example, that the pulse rate or breathing rate of user is above a predetermined level, the skin conductance of user is below a predetermined level (possibly an indication of sweating), or the blood oxygen level of the user is not within a predetermined range.

The first haptic signal is transmitted to one or more second HCDUs over the communication line and is input to the CPU of the second HCDUs. The CPU of each HCDU is configured to analyze the input first haptic signal and generate one or more output second haptic signals that are transmitted to the haptic devices associated with the send HCDU. In addition to the input first signal, the output second haptic signal may also depend on any one or more of the inputs from any one or more of the associated input devices. The generated output second haptic signal may also depend on any one or more rules or algorithms previously stored in the memory. Generation of the second haptic signal activates one or more of the associated haptic devices to generate a corresponding haptic effect on the body of the user associated with the second HCDU.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows a system wherein a first user generates haptic effects in a haptic device of a second user, in accordance with one embodiment of the invention;

FIG. 2 shows a schematic depiction of a haptic communication driving unit (HCDU) for use in the embodiment of the system of FIG. 1;

FIG. 3 shows a flow chart of a method of generating a signal by a first user indicative of one or more haptic effects that is transmitted to a second user, in accordance with one embodiment of the invention; and

FIG. 4 shows a flow chart of a method for generating a haptic signal by a second user upon receipt of a signal from a first user, in accordance with one embodiment of the invention.

### DETAILED DESCRIPTION OF THE INVENTION

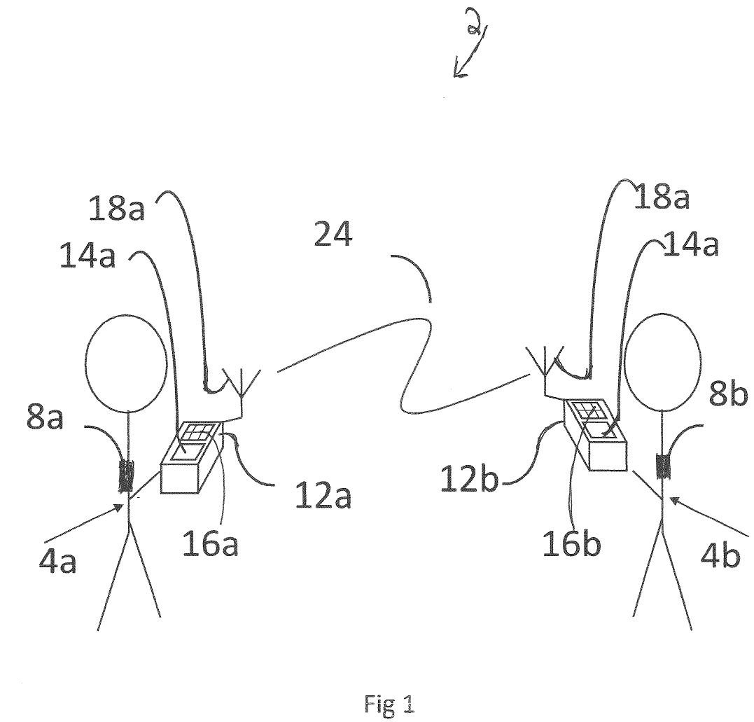

FIG. 1 shows a system 2 involving generation of haptic stimulation to a user in accordance with one embodiment of the invention. The system 2 is used by two or more users. FIG. 1 shows the system 2 used by two users 4a and 4b. This is by way of a non-limiting example only, and the system of the invention may be implemented with any number of users that is at least two.

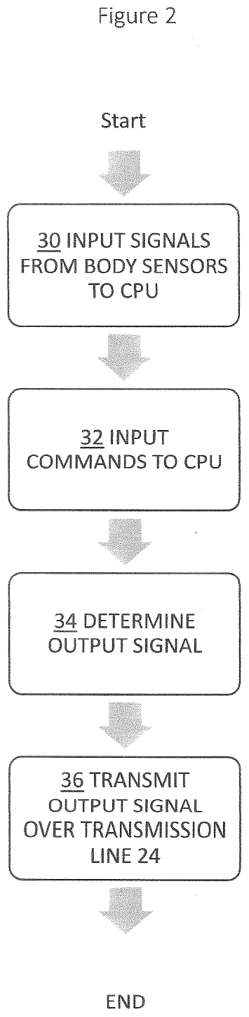

The users 4a and 4b are each provided with a haptic communication driving unit (HCDU) 12a and 12b, respectively. The HCDUs 12a and 12b are shown schematically in FIG. 2. The each HCDU includes a user input device 16a and 16b that may be, for example, in the form of a keypad, touch screen, or joy-stick. The each HCDU may also include a screen 14a and 14b for providing a user with relevant information or images. The HCDU further includes a transceiver 18a and 18b that allows each HCDU of the system 2 to communicate with the other HCDUs of the system, as explained below. The HCDU also includes a computer processing unit (CPU) 20, having a memory 22. The CPU 20 and the memory 22 may be located in a common housing together with the input device and the transceiver or may be located remotely from the housing.

Each of the users 4a and 4b is provided with one or more haptic devices 8a and 8b, respectively. The haptic devices 8a and 8b are applied to a body surface of the user. For example, the haptic devices 8 may be incorporated into a vest worn on the torso of the user, or in the form of a wrist band worn around the user's wrist. A haptic device may be incorporated into a furniture item such as a chair or couch. The haptic devices 8a and 8b comprise one or more haptic transducers that convert electric signals into haptic signals which generate haptic effects in one or more locations on the body surface of the user to which the haptic device is applied. Each user's haptic device 8a and 8b is under the control of the respective user's HCDU.

The HCDUs 12a and 12b of the system 2 communicate with each other over a communication line 24. The communication line 24 may be a wired connection or a wireless connection. If the users 4a and 4b are located in proximity to each other, for example, in the same room, the communication line 24 may be, for example, a WiFi or Bluetooth communication channel. If the users are remotely located, the HCDUs may communicate over the Internet, or a local area network (LAN). Communication between the HCDUs allows the users to share various forms of content with each other. The content may be for example, music or a video film. The content may also be a gaming application in which the users compete with one another in a gaming environment.

Users 4a and 4b are also provided with one or more body sensors 16a and 16b, respectively. One or more of the body sensors may be motion detectors that sense motion or movement of the user. One or more of the body sensors may sense a physiological parameter of the user such as pulse rate, breathing rate, body temperature, skin conductance or blood oxygen level. Each body sensor generates a signal that is input to the CPU 20a or 20b, in the user's HCDU. The CPU is configured to analyze signals input from the one or more body sensors and detect a motion, gesture, or movement performed by the user and/or to determine values of any one or more of the various physiological body parameters.

A user's CPU 20a or 20b is further configured to generate a signal that is transmitted to one or more other HCDUs in the system over the communication channel 24.

As a concrete example, the CPU of the user 4a may generate a signal to the HCDU 12b of the user 4b. Upon receipt of the signal by the HCDU 12b, the received signal is analyzed by the CPU 20b of the HCDU 12b to determine an appropriate haptic signal that is to be sent to the haptic device 8b of user 4b.

Generation of a signal by the CPU of user 4a to the HCDU 12b of the user 4b, may occur when any one or more predetermined conditions are met. User 4a may, for example, input a command using the input device of user 4a's HCDU 12a that activates the CPU of HCDU 12a to generate a signal corresponding to the command. Alternatively or additionally, the CPU of HCDU 12a may generate a signal when user 4a has performed a particular motion or gesture, or when any one or more physiological parameters of user 4a satisfy one or more predetermined conditions. Such conditions may be, for example, that the pulse rate or breathing rate of user 4a is above a predetermined level, the skin conductance of user 4a is below a predetermined level (possibly an indication of sweating), or the blood oxygen level of user 4a is not within a predetermined range.

Moreover, the CPU of user 4a's HCDU may be configured so that the signal generated by the CPU of user 4a depends on any one or more of one or more predetermined motions or any one or more of the values of the various body parameters.

The signal generated by the CPU of user 4a is transmitted to the HCDU of user 4b over the communication line 24 and is input to the CPU of user 4b's HCDU. User 4b's CPU is configured to analyze the input signal and generate one or more output haptic signals that are transmitted to user 4b's haptic devices 8b. In addition to the input signal that was received from user 4a, the generated output signal may also depend on any one or more of the signals that are input to user 4b's CPU from any one or more of the user 4b's body sensors 16b. The generated output signal may also depend on any one or more of the signals that are input to user 4b's CPU from any one or more of the user 4b's input devices. The generated output signal may also depend on any one or more rules or algorithms previously stored in the memory 22 of user 4b's HCDU. Upon receipt of the signal output from user 4b's CPU by 4b's haptic device 8b, the haptic device 8b generates a corresponding haptic effect on user 4b's body surface.

As a non-limiting, non-binding example, in a gaming environment, user 4a might “attack” user 4b with a “weapon”, and in response to the attack, the CPU of the HCDU 12a of user 4a would generate a signal to activate the haptic device 8b of user 4b to generate an appropriate sensation in the body of user 4b corresponding to such an attack. The signal generated by user 4a's CPU could reflect a recent movement or gesture performed by user 4a (such as “an attack gesture”) as well as the physiological state of user 4a. Similarly, when the signal generated by user 4a's CPU is received by the CPU of user 4b, the haptic signal generated by user 4b's CPU may reflect, in addition to information contained in the signal received from user 4a, recent movement or gestures performed by user 4b, as well as the physiological state of user 4b.

The HCDU may be, for example, a game HCDU running haptic communication enabled software, a personal computer, or a virtual reality (VR) system. One or more of the input devices may be devices such as cameras; finger movement sensing interfaces; general movement sensing interfaces; environmental sensors; body biometric sensors such as heart rate, respiratory, body heat etc. The HCDU may also include output devices such as haptic feedback, visuals and audio output devices.

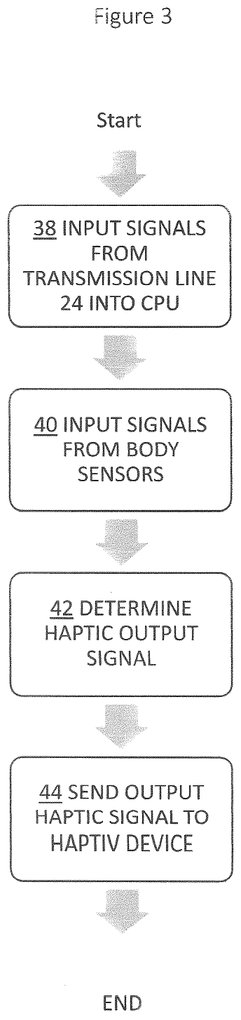

FIG. 3 shows a flow chart of an exemplary process 31 by which a signal is generated by the CPU of a source user and transmitted to the CPU of a recipient user over the transmission line 24, in accordance with oe embodiment of the invention. In the process 31, as an example, the source user is the user 4a, and the recipient user is the user 4b.

In step 30, signals from the body sensors attached to the body of the source user 4a are input to user 4a's CPU. In optional step 32, one or more commands are input to user 4a's CPU by user 4a. Then in step 34, user 4a's CPU determines a signal to be transmitted to user 4b's CPU, where the determined signal is determined in a process involving the input signals from user 4a's body sensors and optionally one or more commands input to user 4a's CPU by user 4a. The determined signal is then transmitted to user 4b's CPU over the transmission line 24 (step 36) and the process terminates.

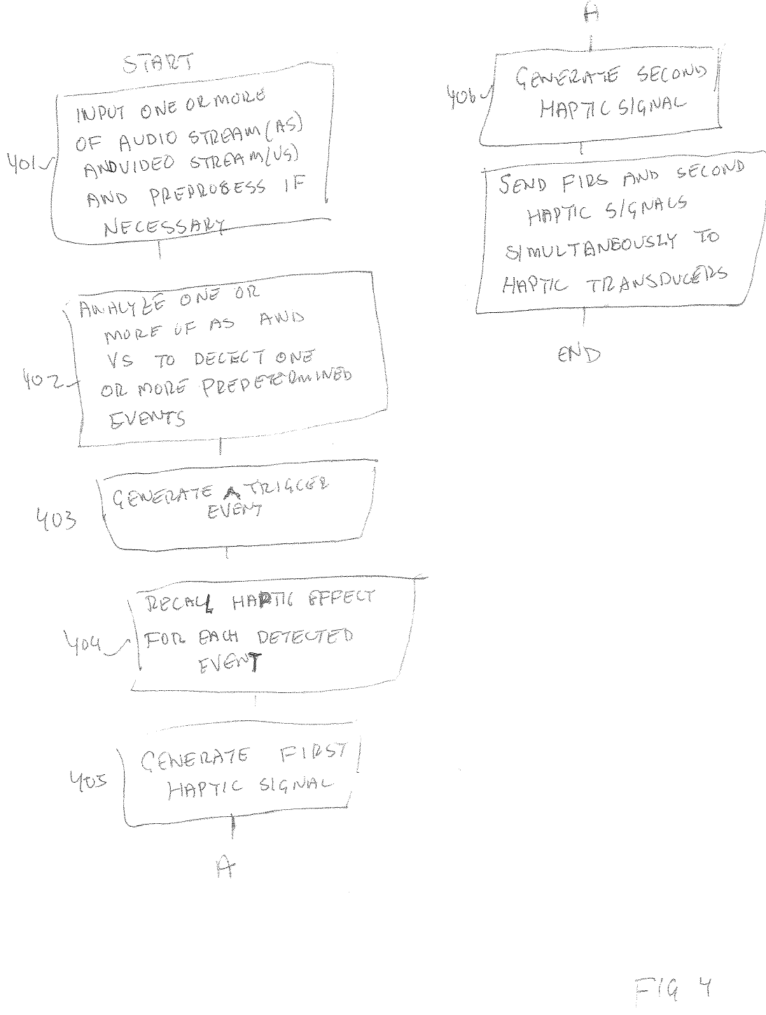

FIG. 4 shows a flow chart of a process by which a haptic signal is generated by CPU of the recipient user, in accordance with another embodiment of the invention. In step 38, upon receipt of the signal from the source user 4a's CPU, the signal from user 4a's CPU is input to recipient user 4b's CPU. In step 40, signals from the body sensors and/or from other input devices of user 4b or from user 4b's input device 16a are input to user 4b's CPU. Then in step 42, user 4b's CPU determines one or more haptic signal to be transmitted to one or more of user 4b's haptic devices 8b, where the haptic signal or signals are determined in a process involving information contained in the signal received from user 4a's CPU as well as the input signals from user 4b's body sensors or user 4b's input device. The determined haptic signal is then transmitted to user 4b's haptic device 8b (step 44) and the process terminates.

The invention claimed is:

1. A system for generating a haptic stimulation interaction among one or more users comprising:
(a) a plurality of user apparatuses, each user apparatus comprising:
i. a haptic communication driving unit (HCDU) including:
a transceiver enabling the HCDU to communicate with other HCDUs in the system over a communication channel; and
a computer processing unit (CPU);
(b) one or more haptic devices adapted to be applied to one or more body surfaces of a user;
wherein the CPU of a first HCDU is configured to determine one or more first haptic signals, each first haptic signal being indicative of a form of haptic stimulation and to transmit the determined haptic signal to one or more second HCDUs in the system;
wherein determination of the one or more first haptic signals at the first HCDU involves one or more signals received at the first HCDU;
and wherein upon receipt of the first haptic signal at one or more second HCDUs, the CPU of the second HCDU generates one or more second haptic signals and sends the one or more second haptic signal to one or more of the haptic devices in a user apparatus associated with the second HCDU to generate one or more haptic effects.

2. The system according to claim 1, wherein one or more of the haptic devices are incorporated into any one or more of a vest, a garment, a wearable device, a handheld device, a human interfacing device or apparatus and a piece of furniture.

3. The system according to claim 1, wherein one or more of the communication channels is a wireless channel.

4. The system according to claim 1, wherein one or more of the apparatuses further comprise one or more first body sensors, each body sensor generating an input to the CPU of the apparatus, and wherein determination of one or more of the first haptic signals and the second haptic signals further depends input from one or more inputs of the body sensors.

5. The system according to claim 4, wherein one or more of the first body sensors is any one or more of a motion detector and a sensor detecting a physiological parameter.

6. The system according to claim 5, comprising one or more sensors detecting a physiological parameter, the physiological parameter being any one or more of a pulse rate, a breathing rate, a body temperature, a skin conductance or blood oxygen level.

7. The system according to claim 1, wherein one or more of the user apparatuses further comprises one or more input devices, and wherein an input device of a user's of a HCDU is configured to generate input to the CPU of the HCDU of the user apparatus, and wherein determination of one or more of the first haptic signals generated by a CPU of a HCDU further involves one or more inputs generated by one or more of the input devices.

8. The system according to claim 1, further comprising a memory, and generation of one of the first haptic effect and the second haptic effect is selected from a set of predetermined set of haptic effects.

9. The system according to claim 8, wherein one or more of the haptic devices are configured to generate a therapeutic effect.

10. The system according to claim 1, further comprising an artificial intelligence (AI) agent or a computer-controlled agent.

11. The system according to claim 8, wherein one or more of the first haptic signals or second haptic signals involve one or more rules or algorithms stored in the memory.
